(19) United States
(12) Patent Application Publication
(10) Pub. No.: US 2015/0311835 A1
(43) Pub. Date: Oct. 29, 2015

(54) MOTOR DRIVING SYSTEM

(71) Applicant: HITACHI AUTOMOTIVE SYSTEMS, LTD., Hitachinaka-shi (JP)

(72) Inventors: Takafumi HARA, Tokyo (JP); Shigehisa AOYAGI, Tokyo (JP); Toshiyuki AJIMA, Tokyo (JP); Rikiya YOSHIZU, Atsugi (JP)

(73) Assignee: HITACHI AUTOMOTIVE SYSTEMS, LTD., Hitachinaka-shi (JP)

(21) Appl. No.: 14/695,873

(22) Filed: Apr. 24, 2015

(30) Foreign Application Priority Data
Apr. 28, 2014 (JP) 2014-092214

(51) Int. Cl. H02P 6/00; H02P 6/16

(52) U.S. Cl. CPC H02P 6/002; H02P 6/16

(57) ABSTRACT

The disclosed invention provides a synchronous motor driving system that reduces vibration attributed to a temporal second-order component of radial electromagnetic force in a three-phase synchronous motor and controls a d-axis current and a q-axis current to reduce noise that is produced as a result of vibration resonating with a structure. A motor driving system of the present invention causes a predefined negative d-axis current to flow into a motor in which a q-axis current is less than or equal to a predefined current value and d-axis inductance and q-axis inductance match substantially. The motor driving system causes a predefined negative d-axis current to flow into a motor in which d-axis inductance and q-axis inductance differ and causes the negative d-axis current to increase with an increase in the q-axis current.

### CLAIM OF PRIORITY

The present application claims priority from Japanese Patent applications serial No. 2014-092214, filed on Apr. 28, 2014, the respective contents of which are hereby incorporated by reference into this application.

### FIELD OF THE INVENTION

The present invention relates to a motor driving system and pertains to a motor driving device that drives and controls a synchronous motor which is used for controlling the rotation speed of, for example, fans, pumps, compressors, spindle motors, etc., used in a positioning device for conveyors and machine tools, and used for controlling torque in electrically-assisted equipment or the like, and an integrated motor system, an electrically-assisted actuation system for brake, an Electric Power Steering system, a hydraulic pump system, an air suspension system, and a compressor driving system which are equipped with the motor driving device.

### BACKGROUND OF THE INVENTION

A compact and highly-efficient three-phase synchronous motor is widely used in various fields of industry, home electronics, motor vehicles, etc. This three-phase synchronous motor rotates by electromagnetic force that acts between a rotor and a stator. There are two electromagnetic forces: one in a circumferential direction and the other in a radial direction. The electromagnetic force in a circumferential direction produces torque that rotates the rotor and the electromagnetic force in a radial direction produces a radial electromagnetic force that vibrates the stator.

Because the radial electromagnetic force is given as the square of magnetic flux density in a gap between the rotor and the stator, the radial electromagnetic force has a main frequency component that is two times as much as a fundamental frequency of current. This radial electromagnetic force with a frequency that is two times as much as the fundamental frequency of current is called a temporal second-order component of radial electromagnetic force. Vibration associated with the temporal second-order component of radial electromagnetic force becomes influential in comparison with other factors, when torque is zero or low. Electromagnetic noise is produced by this vibration and the noise increases by resonating with a structure.

Vibration attributed to the temporal second-order component of radial electromagnetic force involves a deformation mode that occurs depending on a combination of the number of poles of magnets and the number of slots of the stator. For example, in the case of a three-phase synchronous motor having 10 poles and 12 slots, a spatial second-order deformation mode occurs in which deformation into an elliptical form occurs. In the case of a three-phase synchronous motor having 8 poles and 12 slots, a spatial fourth-order deformation mode occurs in which deformation into a square form occurs. Vibration associated with these deformation modes decreases in inverse proportion to the fourth power of the spatial order. Hence, vibration in the spatial second-order deformation mode is ten times or more as much as that in the spatial fourth-order deformation mode.

As a countermeasure against vibration in the spatial second-order mode, an approach that changes the number of poles and the number of slots has so far been performed. However, because changing the number of poles and the number of slots entails a change to the design of a three-phase synchronous motor, a manufacturing period and man-hours grow. In addition, because there is a tradeoff relation between design of electromagnetic force in a circumferential direction to suppress cogging torque and torque pulsation and design of electromagnetic force in a radial direction to suppress vibration due to the temporal second-order component of radial electromagnetic force, it is difficult to fulfill both design requirements only by changing the number of poles and the number of slots.

An invention described in Japanese Patent Laid-Open No. 2008-17660 (hereinafter referred to as Patent Document 1) addresses a radial electromagnetic force with a frequency that is six times as much as the above fundamental frequency of current. This is called a temporal sixth-order component of radial electromagnetic force. In Patent Document 1, it is described that current commands are generated to suppress a vibration component associated with such sixth-order component. Current commands are generated in a manner such that current-torque mapping is prepared beforehand and a current command generator generates a current command using this mapping, according to a given torque command.

### SUMMARY OF THE INVENTION

As requirement specifications for three-phase synchronous motors, in addition to torque and rotation speed, tranquility in sound is also important. Especially, for electric systems which are driven by a three-phase synchronous motor, there is a large requirement of tranquility in sound when the motor operates under light load such as zero torque and low torque. For electric systems, particularly, those on motor vehicles, it is difficult to take countermeasures against vibration and noise with vibration damping materials, sound absorbing materials, etc. in terms of an installation space for a system using a three-phase synchronous motor, weight reduction, and cost.

Consequently, a three-phase synchronous motor taking tranquility in sound into account is hoped for. Noise of a three-phase synchronous motor is produced as a result of vibration associated with the temporal second-order component of radial electromagnetic force, resonating with a structure, and this noise is predominant when the motor operates under light load. An approach described in Patent Document 1 of related art suppresses vibration and noise attributed to a temporal sixth-order component of radial electromagnetic force. However, the temporal second-order component of radial electromagnetic force that is addressed by the present invention is larger than the temporal sixth-order component of radial electromagnetic force and reducing vibration and noise attributed to the second-order component is a problem to address.

An object of the present invention is to provide a synchronous motor driving system that reduces vibration attributed to the temporal second-order component of radial electromagnetic force in a three-phase synchronous motor and controls a d-axis current and a q-axis current to reduce noise that is produced as a result of vibration resonating with a structure.

A motor driving device pertaining to the present invention has a motor control device including a power converter that converts a direct current to an alternating current, a synchronous motor connected to the power converter, and a controller that detects a rotor position and motor currents of the synchronous motor and performs PWM control of the motor currents in response to a detected position. The controller causes a preset negative d-axis current to flow, when a q-axis current is close to approximately 0.

A motor driving device pertaining to the present invention has a motor control device including a power converter that converts a direct current to an alternating current, a synchronous motor connected to the power converter, and a controller that detects a rotor position and motor currents of the synchronous motor and performs PWM control of the motor currents in response to a detected position. The controller causes a predefined negative d-axis current to flow into a motor in which a q-axis current is less than or equal to a predefined current value and d-axis inductance and q-axis inductance match substantially. The controller causes a predefined negative d-axis current to flow into a motor in which d-axis inductance and q-axis inductance differ and causes the negative d-axis current to increase with an increase in the q-axis current.

According to a motor driving system pertaining to a preferred embodiment of the present invention, it is possible to reduce noise that is produced as a result of vibration resonating with a structure, when torque is zero or low. In addition, it is possible to reduce noise even when torque is high, but with a smaller degree of reduction than when torque is low.

Other objects and features of the present invention will be clarified through embodiments that will be described below.

### BRIEF DESCRIPTION OF THE DRAWINGS

FIG. 1 is a block diagram depicting the structure of a three-phase synchronous motor driving system according to a first embodiment of the present invention;

FIG. 2 represents current operating points in a current command converter 3 in FIG. 1 pertaining to the present invention;

FIG. 3 depicts the structure of a controller 2 in a block diagram in FIG. 1;

FIG. 4 is a diagram of an electrically-assisted actuator for brake pertaining to a second embodiment of the present invention;

FIG. 5 is a diagram of an Electric Power Steering pertaining to a third embodiment of the present invention;

FIG. 6 is a diagram of a general pump driving system pertaining to a fourth embodiment of the present invention;

FIG. 7 is a diagram of outdoor equipment in an air conditioning system pertaining to a fifth embodiment of the present invention;

FIG. 8 is a diagram of an elevator system pertaining to a sixth embodiment of the present invention; and

FIG. 9 is a diagram of a railroad vehicle system pertaining to a seventh embodiment of the present invention.

### DETAILED DESCRIPTION OF EMBODIMENTS

In the following, embodiments of the present invention are described by way of the drawings.

### First Embodiment

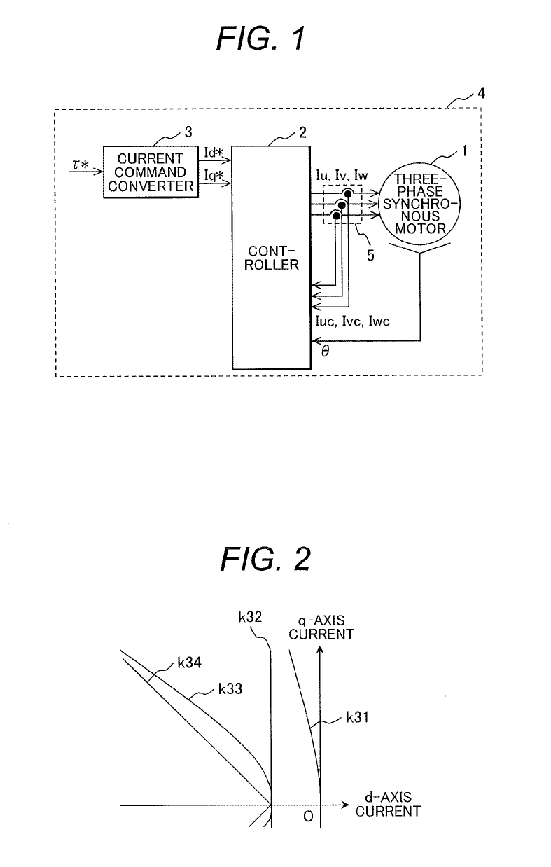

Using FIGS. 1 to 3, descriptions are provided about a first embodiment that is a three-phase synchronous motor driving system pertaining to the present invention.

A three-phase synchronous motor driving system 4 which is depicted in FIG. 1 is intended to drive a three-phase synchronous motor 1 and configured including a controller 2, a current command converter 3, and the three-phase synchronous motor 1 that is to be driven.

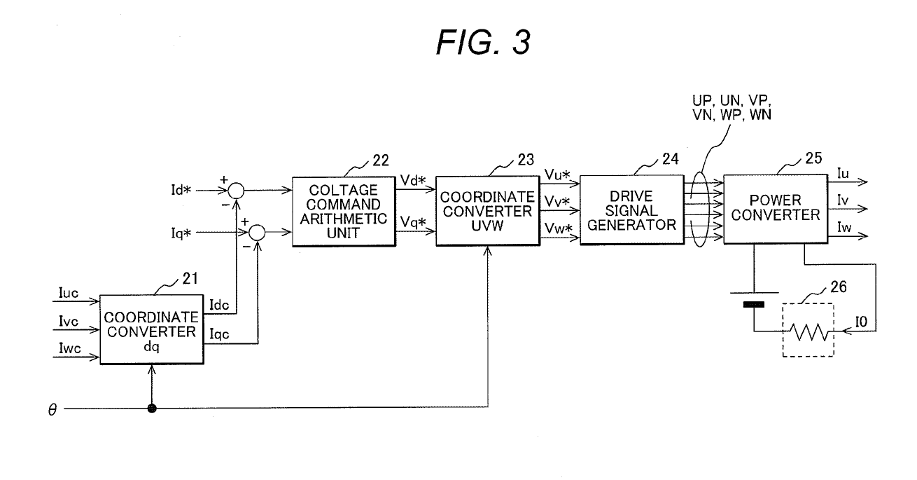

First of all, the structure of the controller 2 is briefly described with FIG. 3. The controller 2 is composed of a coordinate converter dq 21, a voltage command arithmetic unit 22, a coordinate converter UVW 23, a drive signal generator 24, and a power converter 25. Three-phase currents Iuc, Ivc, Iwc and a rotor phase θ which have been detected are first converted to a d-axis current detected value Idc and a q-axis current detected value Iqc by the coordinate converter dq 21. Then, a difference between a d-axis current command value Id* which is output by the current command converter 3 and the d-axis current detected value Idc and a difference between a q-axis current command value Iq* and the q-axis current detected value Iqc are input to the voltage command arithmetic unit 22. The voltage command arithmetic unit 22 outputs a d-axis voltage command value Vd* and a q-axis voltage command value Vq*.

Using the detected rotor phase θ, the coordinate converter UVW 23 gives a U-phase voltage command value Vu*, a V-phase voltage command value Vv*, and a W-phase voltage command value Vw*. Based on these voltage command values, the drive signal generator 24 generates pulse width modulation signals and outputs a U-phase current Iu, a V-phase current Iv, and a W-phase current Iw which drive the power converter 25.

To detect the currents for the three-phase synchronous motor 1, it is desirable to directly detect the three-phase currents which are fed from the controller 2 to the three-phase synchronous motor 1 by a current detector 5 as depicted in FIG. 1. An alternative is to detect a DC current 10 that flows through a shunt resistor 26 which is depicted in FIG. 3 and reproduce three-phase currents; these currents Iuc, Ivc, Iwc may be used.

While it is desirable to use a position sensor such as a resolver to detect a rotor phase of the three-phase synchronous motor 1, an alternative may be using an output of position sensor-less control that estimates a rotor phase from three-phase currents and three-phase voltages of a motor.

Next, the structure of the current command converter 3 is briefly described. The current command converter 3 takes input of a torque command τ* and outputs a d-axis current command value Id* and a q-axis current command value Iq*. A current command is generated by selecting one of cur rent operating points of lines k32 to k34 in FIG. 2 depending on a torque command and the three-phase synchronous motor characteristics. By making the motor operation follow current command values based on these current operating points, vibration displacement attributed to a temporal second-order component of radial electromagnetic force is reduced and the resulting noise is reduced. Details on the lines k32 to k34 in FIG. 2 will be described below.

Vibration displacement attributed to the temporal second-order component of radial electromagnetic force has a characteristic expressed in Equation (1) according to a simple calculation of magnetic flux density in a gap between the rotor and stator of a motor. x is vibration displacement, k is a proportional constant, Ke is an induced voltage constant, kd is a proportional constant of d-axis, Id is a d-axis current, kg is a proportional constant of q-axis, and Iq is a q-axis current. These constants k, Ke, Kd, and kq are obtained by experiment or calculation.

x=k\sqrt{(Kₑ+k_{d}I_{d})²+(k_{q}I_{q})²} Equation (1)

Next, torque of the three-phase synchronous motor 1 is expressed by Equation (2). T is torque, P is the number of pole pairs, Ld is d-axis inductance, and Lq is q-axis inductance.

T=P{Kₑ+(L_{d}−L_{q})I_{d}}I_{q} Equation (2)

By combining Equations (1) and (2) in the present embodiment, a current operating point that minimizes vibration is derived and this current operating point is used. FIG. 2 represents the current operating points of the d-axis current and the q-axis current derived in the present embodiment. A straight line k32, a curved line k33, and a straight line k34 pass through a predefined d-axis current, when the q-axis current is zero. A curved line k31 is a maximum torque curve in which torque is maximized with a given current which has been used conventionally.

The straight line k32 is a curve that minimizes vibration in a Surface Permanent Magnet Motor in which d-axis inductance and q-axis inductance match substantially. This curve is a line that means flowing of the predefined negative d-axis current, which is represented by the straight line k32 in FIG. 2. That is, a preset negative d-axis current is made to flow, when the q-axis current is close to approximately 0.

The curved line k33 is a curve that minimizes vibration in an Interior Permanent Magnetic Motor in which d-axis inductance and q-axis inductance differ. This curve is a quadratic curve which is indicated by the curved line k33 in FIG. 2. To simplify calculation, a straight line by which the quadratic curve has been approximated, which is represented by the straight line k34, may be used instead of the curved line k33 in FIG. 2. By using one of the lines k32 to k34 which is suited for a three-phase synchronous motor type, it is possible to reduce the vibration displacement attributed to the temporal second-order component of radial electromagnetic force.

Even in the case of a generator mode in which the q-axis current is negative, by making current operating points in the second quadrature, like those represented in FIG. 2, line-symmetric with respect to the d-axis current, it is possible to obtain the same effect of reducing vibration and noise as in a motor mode. That is, for a motor in which d-axis inductance and q-axis inductance differ, a predefined negative d-axis current is made to flow into the motor and the negative d-axis current is made to increase with an increase in the q-axis current.

A motor driving system configured as described above makes it possible to reduce vibration and prevent increase of magnetic noise due to resonation, independently of a three-phase synchronous motor type.

### Second Embodiment

Next, a second embodiment of the present invention is described.

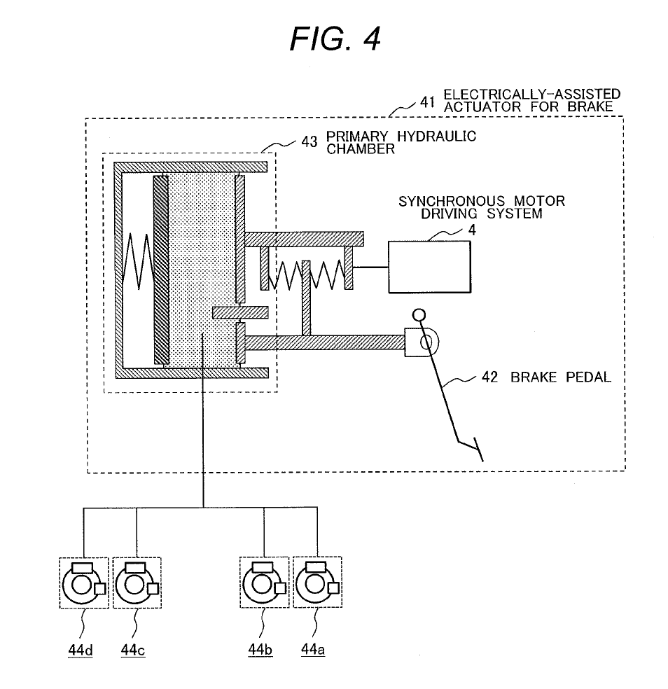

FIG. 4 depicts the structure of an electrically-assisted actuator for brake. The electrically-assisted actuator for brake 41 has a three-phase synchronous motor driving system 4 that controls the pressure of fluid inside a primary hydraulic chamber 43 and thereby adjusts a regenerative braking force and a frictional braking force that tightens brake calipers 44a to 44d. Since this electrically-assisted actuator for brake 41 conveys force reactive to the fluid pressure to the driver via a brake pedal 42, the driver's sensitivity to vibration and noise is high. There is a strong requirement of noise reduction, i.e., reducing vibration and noise attributed to the three-phase synchronous motor, particularly, when the motor operates in a low torque range, while the driver lightly presses the brake pedal, and when the motor operates in conditions not intended by the driver. In response to that requirement, by the use of the motor driving system 4 described in First Embodiment section, it is possible to reduce vibration in a stop state or a low torque state and realize a low-vibration, low-noise actuator as the electrically-assisted actuator for brake.

### Third Embodiment

Next, a third embodiment of the present invention is described.

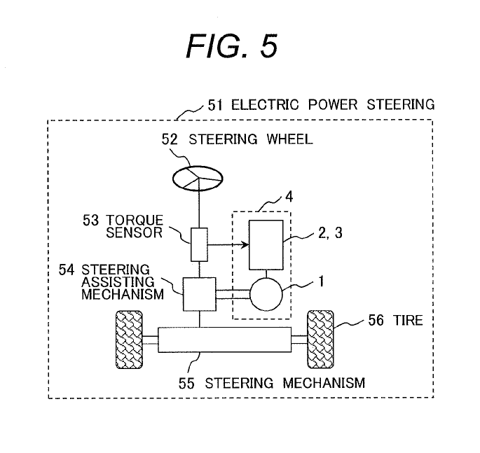

FIG. 5 depicts the structure of an Electric Power Steering. The Electric Power Steering 51 detects the rotary torque of a steering wheel 52 through a torque sensor 53, assists steering force in response to an input from the steering wheel 52 by means of a three-phase synchronous motor 1 within a synchronous motor driving system 4 and via a steering assisting mechanism 54, and provides an output to a steering mechanism 55. Tires 56 are steered by the steering mechanism 55. This Electric Power Steering 51 directly links with the driver via the steering wheel 52, the driver's sensitivity to vibration and noise is high. Vibration and noise attributed to the three-phase synchronous motor are larger than other on-vehicle structures, particularly, in a state when the driver slowly turns the steering wheel 52 and in a state when the driver holds the steering wheel still. But, by the use of the motor driving system 4 described in the First Embodiment section, it is possible to reduce vibration in a state when the driver slowly turns the steering wheel 52 and in a state when the driver holds the steering wheel still and realize a low-vibration, low-nose Electric Power Steering.

### Fourth Embodiment

Next, a fourth embodiment of the present invention is described.

FIG. 6 depicts the structure of a general pump driving system and this is used in transmission hydraulics and brake hydraulics inside a motor vehicle. In FIG. 6, reference numeral 4 denotes a synchronous motor driving system 4 depicted in FIG. 1 and an oil pump 61 is attached to a three-phase synchronous motor 1. Hydraulic pressure of a hydraulic circuit 62 is controlled by the oil pump 61. The hydraulic circuit 62 is comprised of a tank 63 which stores oil, a relief valve 64 which keeps the hydraulic pressure equal to or less than a setup value, a solenoid valve 65 which switches over the hydraulic circuit, and a cylinder 66 which operates as a hydraulic actuator.

The oil pump 61 generates hydraulic pressure under control of the synchronous motor driving system 4 including the oil pump 61 and drives the cylinder 66 which is the hydraulic actuator. In the hydraulic circuit, when the circuit is switched over by the solenoid valve 65, load of the oil pump 61 changes. Load disturbance occurs in the synchronous motor driving system 4 and the three-phase synchronous motor 1 vibrates and produces noise. However, by the use of the motor driving system 4 described in First Embodiment, it is possible to reduce vibration and reduce noise in a stop state or a low torque state.

### Fifth Embodiment

Next, a fifth embodiment of the present invention is described.

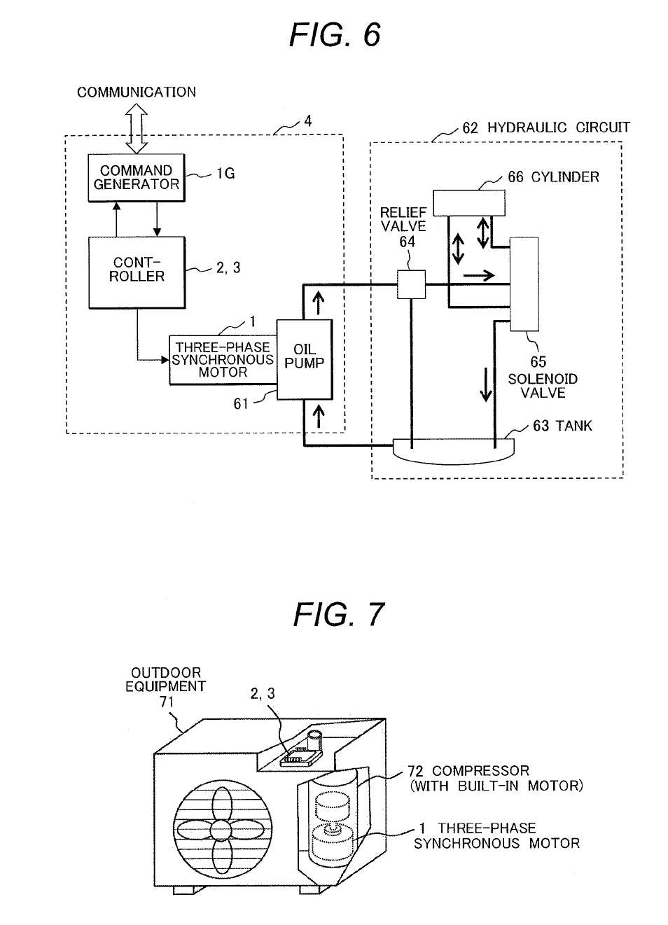

FIG. 7 depicts outdoor equipment 71 of an air conditioning system of a room air-conditioner or a package air-conditioner. The outdoor equipment 71 of the air conditioning system includes a three-phase synchronous motor 1, a controller 2, and a current commanding unit 3 and is configured with components such as a compressor 72 and a fan. Among them, the power source of the compressor 72 is the three-phase synchronous motor 1 that is built in the compressor.

Year after year, a progress is made in reducing vibration and noise in air conditioning systems. There is a need to achieve a low-vibration, low-noise air conditioning system, particularly, in a range from low torque to high torque. But, in previously existing motor driving systems, when the vibration of the three-phase synchronous motor is coincident with a resonance point of a structure, noise increases. Consequently, countermeasures have so far taken for reducing vibration and noise with vibration damping materials and sound absorbing materials. By the use of the motor driving system 4 described in First Embodiment, it is realize to reduce vibration and noise.

The above motor driving system may be used in an air suspension system as a system employing compression members.

### Sixth Embodiment

Next, a sixth embodiment of the present invention is described.

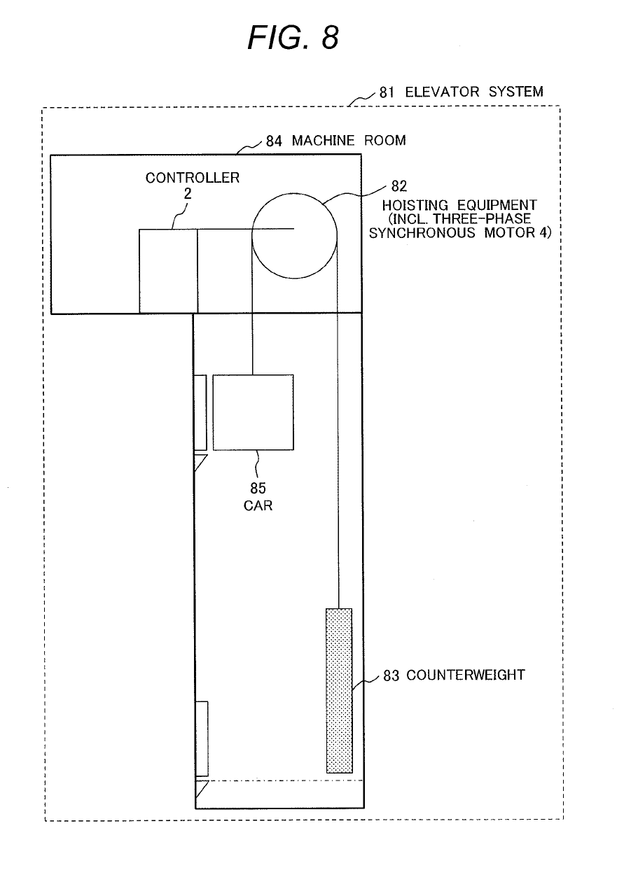

FIG. 8 depicts the structure of an elevator system. The elevator system 81 is composed of hoisting equipment 82 including a three-phase synchronous motor 4, a counterweight 83, a machine room 84, and a car 85. Among them, the power source of the hoisting equipment is the three-phase synchronous motor that is built in the hoisting equipment.

The machine room 84 in the elevator system is located near the passenger room and sensitivity to reduction of vibration and noise is high. By the use of the motor driving system 4 described in First Embodiment, it is possible to satisfy both specifications regarding installation space restriction and weight and specifications regarding vibration and noise.

### Seventh Embodiment

Next, a seventh embodiment of the present invention is described.

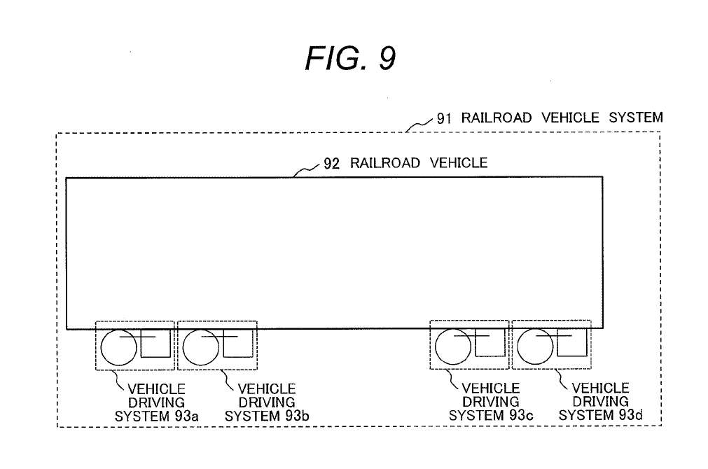

FIG. 9 depicts a railroad vehicle system that is driven by three-phase synchronous motors. The railroad vehicle system 91 is composed of a railroad vehicle 92 and vehicle driving systems 93a thru 93d. Each of the vehicle driving systems 93a thru 93d includes a synchronous motor driving system 4 and each wheel is driven by a three-phase synchronously motor. In the case of railroad vehicles, running sound and aerodynamic sound are predominant, when the vehicle runs at high speed, whereas noise due to vibration from the three-phase synchronous motors becomes a major source of noise, when the vehicle runs at low speed. During driving the railroad vehicle under light load, when the vehicle runs at low speed and slowly accelerates and decelerates, particularly, noise attributed to such vibration becomes noticeable. Thus, by the use of the motor driving system 4 described in First Embodiment, it is possible to realize reduction of vibration and noise when the railroad vehicle accelerates and decelerates in a low torque and light load range.

While the embodiments of the present invention have been described specifically hereinbefore, it is obvious that the present invention is not limited to the foregoing embodiments and various modifications may be made therein without departing from the scope of the invention.

Although the described embodiments principally assume the use of a motor mode in which a q-axis current is positive, the effect of reducing vibration and noise can also be obtained even in a generator mode in which the motor is driven externally and a q-axis current is negative by feeding a negative d-axis current to the motor in the same way as in the motor mode.

1. A motor driving device having a motor control device comprising:
a power converter that converts a direct current to an alternating current;
a synchronous motor connected to the power converter; and
a controller that detects a rotor position and motor currents of the synchronous motor and performs PWM control of the motor currents in response to a detected position,
wherein the controller causes a preset negative d-axis current to flow, when a q-axis current is close to approximately 0.

2. A motor driving device having a motor control device comprising:
a power converter that converts a direct current to an alternating current;
a synchronous motor that is connected to the power converter; and
a controller that detects a rotor position and motor currents of the synchronous motor and performs PWM control of the motor currents in response to a detected position,
wherein the controller causes a predefined negative d-axis current to flow into a motor in which a q-axis current is less than or equal to a predefined current value and d-axis inductance and q-axis inductance match substantially, and
wherein the controller causes a predefined negative d-axis current to flew into a motor in which d-axis inductance and q-axis inductance differ and causes the negative d-axis current to increase with an increase in the q-axis current.

3. An electrically-assisted actuation system for brake comprising:
a motor driving device as set forth in claim 1;
a three-phase synchronous motor that is driven and controlled by the motor driving device; and,
an electrically-assisted actuator for brake, the actuator being driven by the three-phase synchronous motor.

4. The electrically-assisted actuation system for brake according to claim 3,
wherein, with a vehicle being at a stop, the controller causes a preset negative d-axis current to flow, when a q-axis current is close to approximately 0.

5. The electrically-assisted actuation system for brake according to claim 3,
wherein, when the vehicle speed has fallen by braking action of the electrically-assisted actuator for brake and the vehicle nearly stops, the controller causes a preset negative d-axis current to flow, when a q-axis current is close to approximately 0.

6. An Electric Power Steering system comprising:
a motor driving device as set forth in claim 1;
a three-phase synchronous motor that is driven and controlled by the motor driving device; and
an Electric Power Steering that is driven by the three-phase synchronous motor.

7. An electric oil pump system comprising:
a motor driving device as set forth in claim 1; and
a three-phase synchronous motor that is driven and controlled by the motor driving device.

8. A pump system comprising:
a motor driving device as set forth in claim 1; and
a three-phase synchronous motor that is driven and controlled by the motor driving device.

9. A compressor system comprising:
a motor driving device as set forth in claim 1; and
a three-phase synchronous motor that is driven and controlled by the motor driving device.

10. An electrically-assisted actuation system for brake comprising:
a motor driving device as set forth in claim 2;
a three-phase synchronous motor that is driven and controlled by the motor driving device; and
an electrically-assisted actuator for brake, the actuator being driven by the three-phase synchronous motor.

11. An Electric Power Steering system comprising:
a motor driving device as set forth in claim 2;
a three-phase synchronous motor that is driven and controlled by the motor driving device; and
an Electric Power Steering that is driven by the three-phase synchronous motor.

12. An electric oil pump system comprising:
a motor driving device as set forth in claim 2; and
a three-phase synchronous motor that is driven and controlled by the motor driving device

13. A pump system comprising:
a motor driving device as set forth in claim 2; and
a three-phase synchronous motor that is driven and controlled by the motor driving device.

14. A compressor system comprising:
a motor driving device as set forth in claim 2; and
a three-phase synchronous motor that is driven and controlled by the motor driving device.
